(19) United States
(12) Patent Application Publication
(10) Pub. No.: US 2020/0166611 A1
(43) Pub. Date: May 28, 2020

(54) DETECTION METHOD, DETECTION DEVICE, TERMINAL AND DETECTION SYSTEM

(71) Applicant: JOMOO KITCHEN & BATH CO., LTD, Nan'an City (CN)

(72) Inventors: Xiaofa LIN, Nan'an City (CN); Xiaoshan LIN, Nan'an City (CN); Jinyu HU, Nan'an City (CN)

(73) Assignee: JOMOO KITCHEN & BATH CO., LTD, Nan'an City (CN)

(21) Appl. No.: 16/590,725

(22) Filed: Oct. 2, 2019

(30) Foreign Application Priority Data
Nov. 22, 2018 (CN) 201811401016.8

(51) Int. Cl. G01S 7/41; G08B 21/02; G08B 7/06; G01S 13/02; G01S 13/42

(52) U.S. Cl. CPC G01S 7/417; G08B 21/02; G01S 13/42; G01S 13/0209; G08B 7/06

(57) ABSTRACT

A detection method, a detection device, a terminal, and a detection system are provided for detecting a state of a target object in a monitoring area. The detection method includes: acquiring point cloud data obtained based on a millimeter-wave radar signal in the monitoring area and preprocessing the point cloud data; extracting features of the preprocessed point cloud data through a stacked auto-encoder network to obtain output data; classifying the output data by a classifier to obtain a classification result; and determining the state of the target object in the monitoring area according to the classification result. A better detection effect can be ensured on the basis of protecting privacy of user.

### CROSS-REFERENCE TO RELATED APPLICATION

This application claims foreign priority benefits under 35 U.S.C. § 119(a)-(d) to Chinese Patent Application No 201811401016.8 filed on Nov. 22, 2018, which is incorporated by reference herein in its entirety.

### TECHNICAL FIELD

The present application relates to, but not limited to, a field of computer technology, in particular to a detection method, a detection device, a terminal, and a detection system.

### BACKGROUND

With the development of computer technology, in more and more scenarios, sensors are used to detect human body states. For example, solutions for detecting whether a human body falls may be divided into a wearable solution, a contact solution, and a contactless solution. In the wearable solution, a user needs to wear some device (for example, a motion sensor) all the time, which leads to inconvenience of the user and limits the usage in some scenarios (for example, a bath scenario). In the contact solution, sensors, such as switches, pressure and vibration sensors, need to be installed near the surface (such as mat, floor, etc.) involved in the impact of a fall of a user. In this solution, the detection accuracy depends on the number and installation location of sensors. In order to improve the detection accuracy, it may be required to modify or redesign the detection environment (for example, an indoor environment for family), which results in a high reconstruction cost. In the contactless solution, usually a camera is used to collect video images, and whether a human body falls is determined according to the collected video images. In this solution, video image collection and detection through the camera are not only greatly affected by the environment, but also violate the user's privacy to some extent (especially in private environments such as a bathroom).

### SUMMARY

The following is an overview of subject matter detailed in this disclosure. This summary is not intended to limit the protection scope of the claims.

Embodiments of this application provide a detection method, a detection device, a terminal, and a detection system, which can ensure a good detection effect on the basis of protecting privacy of user.

In one aspect, an embodiment of this application provides a detection method for detecting a state of a target object in a monitoring area. The above detection method includes: acquiring point cloud data obtained based on a millimeter-wave radar signal in the monitoring area, and preprocessing the point cloud data; extracting features of the preprocessed point cloud data through a stacked auto-encoder network to obtain output data; and classifying the output data by a classifier to obtain a classification result, and determining the state of the target object in the monitoring area according to the classification result.

In another aspect, an embodiment of this application provides a detection device for detecting a state of a target object in a monitoring area. The detection device includes a preprocessing module, which is adapted to acquire point cloud data obtained based on a millimeter-wave radar signal in the monitoring area and preprocess the point cloud data; a stacked auto-encoder network, which is adapted to extract features of the preprocessed point cloud data to obtain output data; and a classifier, which is adapted to classify the output data to obtain a classification result, and determine the state of the target object in the monitoring area according to the classification result.

In yet another aspect, an embodiment of this application provides a terminal including a processor and a memory. The memory stores a detection program, which, when executed by the processor, cause the processor to implement steps of the above detection method.

In still another aspect, an embodiment of this application provides a detection system for detecting a state of a target object in a monitoring area. The above detection system includes: an ultra-wideband radar sensor and a data processing terminal. The ultra-wideband radar sensor is adapted to transmit a millimeter-wave radar signal and receive a returned millimeter-wave radar signal in the monitoring area, and generate point cloud data according to the received millimeter-wave radar signal. The data processing terminal is adapted to acquire the point cloud data from the ultra-wideband radar sensor; preprocess the point cloud data; extract features of the preprocessed point cloud data through a stacked auto-encoder network to obtain output data; classify the output data by a classifier to obtain a classification result; and determine the state of the target object in the monitoring area according to the classification result.

In still another aspect, an embodiment of this application provides a computer readable medium in which a detection program is stored for implementing steps of the above detection method when the detection program is executed by a processor.

In embodiments of this application, a state is detected based on a millimeter-wave radar signal, privacy of user can be protected, and it is especially suitable for a state detection in a private environment such as a bathroom. A stacked auto-encoder network is used to extract features and customize features in an unsupervised manner, which is suitable for a situation where actual training data are lacking. On the basis of protecting privacy of user, a good detection effect is ensured, embodiments of this application are not only convenient to implement, but also applicable to various environments.

After reading and understanding accompanying drawings and detailed description, other aspects may be understood.

### BRIEF DESCRIPTION OF THE DRAWINGS

The accompanying drawings are used for providing a further understanding of the technical solution of the present application and form a part of the specification, and are used together with the embodiments of the present application to explain the technical solution of the present application, but do not constitute a limitation on the technical solution of the present application.

FIG. 1 is a flowchart of a detection method provided in an embodiment of the present application.

FIG. 2 is a diagram showing an example of an application environment of a detection method provided in an embodiment of the present application.

FIG. 3 is a schematic diagram of a detection device provided in an embodiment of the present application.

FIG. 4 is a schematic diagram of an application example provided in an embodiment of the present application.

FIG. 5 shows an example of a point cloud map corresponding to point cloud data acquired in an embodiment of the present application.

FIG. 6 shows an example of point cloud maps of human body during a falling process in an embodiment of the present application.

FIG. 7 is a schematic diagram of a terminal provided in an embodiment of the present application.

FIG. 8 is a schematic diagram of an example of a terminal provided in an embodiment of the present application.

FIG. 9 is a block diagram of a detection system provided in an embodiment of the present application.

### DETAILED DESCRIPTION

Details of embodiments of this application are given below in conjunction with the accompanying drawings. It should be noted that, without conflict, embodiments in this application and the characteristics in the embodiments may be arbitrarily combined with each other.

The steps illustrated in the flowchart may be performed in a computer system such as a set of computer-executable instructions. Although a logical order is shown in the flowchart, in some cases, the steps shown or described may be executed in an order different from here.

A detection method, a detection device, a terminal and a detection system are provided in embodiments of the present application for detecting a state of a target object in a monitoring area. Target objects may include movable objects such as a human body, an animal body, etc. Monitoring areas may include indoor environments such as a bedroom, a bathroom, etc. However, this application is not limited thereto.

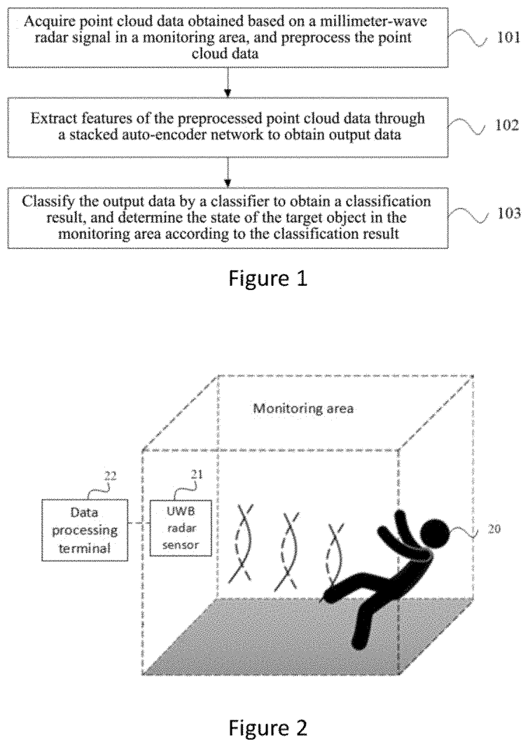

The FIG. 1 is a flowchart of a detection method provided in an embodiment of the present application. The detection method provided in this embodiment may be performed by a terminal (for example, a mobile terminal such as a notebook computer, a personal computer, or a fixed terminal such as a desktop computer). In an exemplary embodiment, the terminal may be integrated with an Ultra Wideband (UWB) radar sensor and placed in a monitoring area for state monitoring. Alternatively, the terminal may be wiredly or wirelessly connected with a UWB radar sensor located in the monitoring area.

As shown in the FIG. 1, the detection method provided by this embodiment includes the following steps 101-103.

In step 101, point cloud data obtained based on a millimeter-wave radar signal in a monitoring area are acquired, and the point cloud data are preprocessed.

In step 102, features of the preprocessed data are extracted through a stacked auto-encoder network to obtain output data.

In step 103, the output data are classified by a classifier to obtain a classification result, and the state of the target object in the monitoring area is determined according to the classification result.

In an exemplary embodiment, a millimeter-wave radar signal may be received by a UWB radar sensor configured in a monitoring area. A plane where the ultra-wideband radar sensor is configured may be perpendicular to the ground in the monitoring area.

In an exemplary embodiment, before step 101, the detection method of the present embodiment may also include: transmitting a millimeter-wave radar signal and receiving a returned millimeter-wave radar signal in the monitoring area through the UWB radar sensor; and generating the point cloud data according to the received millimeter-wave radar signal.

The UWB radar sensor may include a transmitter and a receiver, the transmitter may transmit a millimeter-wave radar signal to the monitoring area, and the receiver may receive a millimeter-wave radar signal returned from the monitoring area.

The point cloud data are recorded in the form of points, and each point may contain three-dimensional coordinates. In other words, when the target object is in the monitoring area, the point cloud data generated based on the millimeter-wave radar signal in the monitoring area may reflect the three-dimensional information of the target object in the monitoring area.

The FIG. 2 is a diagram showing an example of an application environment of the detection method provided in the present embodiment. In this example, the target object may be a user 20, and the monitoring area may be a bathroom environment. The detection method in this example may be used to detect whether the user 20 falls in the bathroom. In this example, since human motion mainly occurs in the direction perpendicular to the floor plane during the falling, in order to obtain the information of the body height of the user 20 to the ground for state recognition, a UWB radar sensor 21 may be configured on the wall perpendicular to the ground. That is, a plane here the UWB radar sensor 21. is configured is perpendicular to the ground in the monitoring area. In this example, the height of the UWB radar sensor 21 to the ground may be about 1.5 meters. However, this is not restricted in the present application.

In this example, the UWB radar sensor 21 may transmit wiredly or wirelessly the acquired point cloud data to a data processing terminal 22, and then the data processing terminal 22 performs the steps 101 to 103 to determine whether the user 20 falls in the monitoring area. In an application example, the data processing terminal 22 may be a smart home control terminal (for example, configured inside or outside a bathroom), a human-computer interaction interface may be provided to the user, for example, prompt information or alarm message may be presented on the human-computer interaction interface when it is detected that the user falls. In another application example, the UWB radar sensor 21 and the data processing terminal 22 may be integrated into one device, for example, a bathroom control terminal located within a bathroom.

In this embodiment, a UWB radar sensor is used for contactless remote sensing. State recognition is performed based on point cloud data obtained from the millimeter wave radar signal. The millimeter wave radar signal has high resolution and high penetrating power, and it can penetrate obstacles and detect very small targets. Moreover, it has a very low power spectral density, preventing it fro being interfered by other radio systems in the same frequency range. By using the millimetere radar signal for detection, not only can privacy protection be achieved, but also detection effect is ensured.

In an exemplary embodiment, a UWB radar sensor may include a single-chip radar sensor of 76 GHz (Gigahertz) to 81 GHz integrated with a Microcontroller Unit (MCU) and a hardware accelerator. This type of radar sensor has a safe high-pass wireless communication capability, can accurately detect the distance, angle and speed of objects, is not affected by environmental conditions such as rain, fog, dust, light and darkness, and has a high penetrating power (it can penetrate materials such as plastic, dry walls and glass).

In an exemplary embodiment, in step 101, preprocessing the point cloud data may include removing noises from the point cloud data with a noise threshold.

In an exemplary embodiment, a stacked auto-encoder network may include two sparse auto-encoders, which are used to extract different features from the preprocessed point cloud data, respectively.

The auto-encoder (AE) is a neural network that reproduces input data as much as possible, a output vector of the AE has the same dimension as its input vector, and usually, a useful input feature is extracted according to some form of the input vector by learning a representation of data or effectively encoding the input data through a hidden layer. The learning of the auto-encoder is unsupervised, that is, no data markers are provided. A typical auto-encoder has an input layer that represents original data or input eigenvectors, a hidden layer that represents feature transformation, and an output layer that matches with the input layer and is used for information reconstruction. When limitation is added on the basis of the auto-encoder (the number of neurons in the hidden layer is less than the number of neurons in the input layer), it is a sparse auto-encoder. The sparse auto-encoder may continuously adjust parameters of the auto-encoder by calculating an error between the output of the auto-encoding and the original input, and finally obtain a trained sparse auto-encoder.

In this exemplary embodiment, the sparse auto-encoder may define its own feature space without supervision by learning training data without data markers. For example, prominent features may be extracted from the preprocessed point cloud data for state recognition.

In an exemplary embodiment, the classification result may include: a probability that the output data belong to any state. In step 103, according to the classification result, determining the state of the target object in the monitoring area may include: determining the maximum probability in the classification result; and determining a state corresponding to the maximum probability as the state of the target object in the monitoring area.

For example, the classifier could include a Softmax regression classifier. However, this is not restricted in the present application. In other implementations, the classifier may include other types of classifiers, such as a logistic classifier.

In an exemplary embodiment, the state of the target object in the monitoring area may include: a falling state, a non-falling state.

The detection method of this embodiment may also include: after determining that the target object is in the falling state in the monitoring area, when a duration in which the target object is in the falling state in the monitoring area meets a preset condition, generating alarm information and performing at least one of the following: sending alarm information to a target terminal; displaying the alarm information; and playing a voice corresponding to the alarm information.

The preset condition may include: the duration in which the target object is in the falling state is greater than or equal to a duration threshold (for example, 40 seconds). However, this is not restricted in the present application. In practical applications, the preset condition may be set according to actual needs.

The target terminal may be a terminal which is preconfigured by a user to receive alarm information. For example, when the target object is the elderly, the target terminal may be a mobile phone of a family member of the elderly.

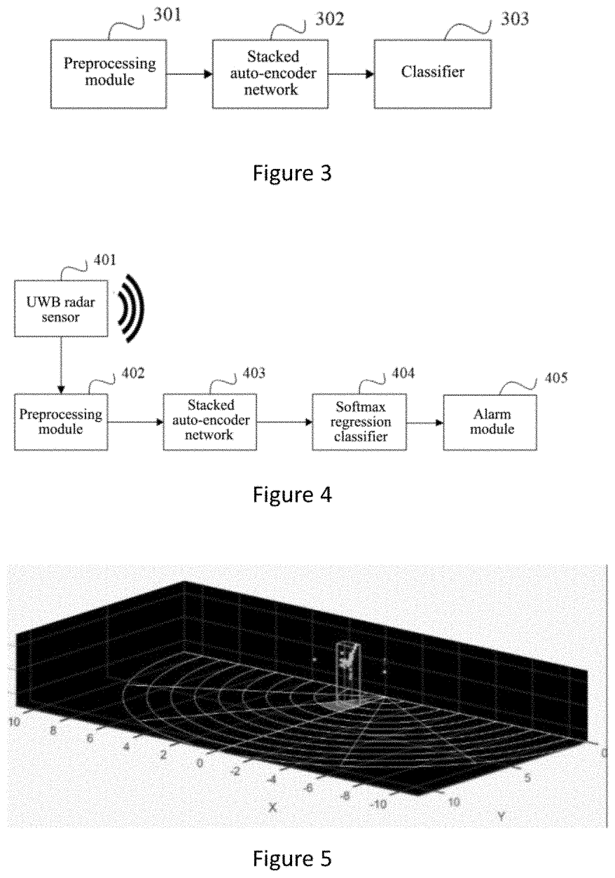

The FIG. 3 is a schematic diagram of a detection device provided by an embodiment of this application. The detection device provided in this embodiment is used for detecting a state of a target object in a monitoring area. As shown in the FIG. 3, the detection device provided by the present embodiment includes a preprocessing module 301, a stacked auto-encoder network 302, and a classifier 303.

The preprocessing module 301 is adapted to acquire point cloud data obtained based on a millimeter-wave radar signal in the monitoring area and preprocess the point cloud data. The stacked auto-encoder network 302 is adapted to extract features of the preprocessed point cloud data to obtain output data. The classifier 303 is adapted to classify the output data to obtain a classification result, and determine the state of the target object in the monitoring area according to the classification result.

In an exemplary embodiment, the millimeter-wave radar signal may be received by a UWB radar sensor (e.g., a UWB radar sensor 21 in the FIG. 2) configured in the monitoring area, and a plane where the UWB radar sensor is configured is perpendicular to the ground in the monitoring area.

In an exemplary embodiment, the stacked auto-encoder network 302 may include two sparse auto-encoders, which are used to extract different features from the preprocessed point cloud data, respectively.

In an exemplary embodiment, states of the target object in the monitoring area may include: a falling state, and a non-falling state.

The detection device of the present embodiment may also include an alarm module adapted to, after the classifier 303 determines that the target object is in the falling state in the monitoring area, and when a duration in which the target object is in the falling state in the monitoring area meets a preset condition, generate alarm information, and perform at least one of the following: sending the alarm information to a target terminal; displaying the alarm information; and playing a voice corresponding to the alarm information.

The relevant description of the detection device provided by the present embodiment may refer to the description of the above embodiment of the detection method, so it is not repeated here.

The FIG. 4 is a schematic diagram of an application example provided in an embodiment of this application. In this application example, detecting whether the elderly (the target object) falls in the bathroom (monitoring area) is described as an example. In this example, a position of the UWB radar sensor 401 configured may be as shown in the FIG. 2, that is, it is configured on the wall perpendicular to the ground and a vertical distance from the ground is 1.5 m. In this example, the UWB radar sensor 401 may transmit a millimeter wave radar signal and receive a returned millimeter wave radar signal in the bathroom, generate real-time point cloud data based on the received millimeter wave radar signal, and transmit the point cloud data obtained in real time (for example, point cloud data obtained at a particular moment may be represented by a frame of a point cloud map) to the data processing terminal, so that the data processing terminal determines in real time whether the elderly falls in the bathroom.

The FIG. 5 shows an example of a point cloud map in this example. Herein, the X-axis may be a direction parallel to the ground, the Y-direction may be a direction parallel to the ground and perpendicular to the X-axis, a plane determined by the X-axis and Y-axis is parallel to the ground, and the Z-axis is a direction perpendicular to the ground. The point cloud diagram shown in the FIG. 5 may reflect a contour and a position of a human body detected in a bathroom.

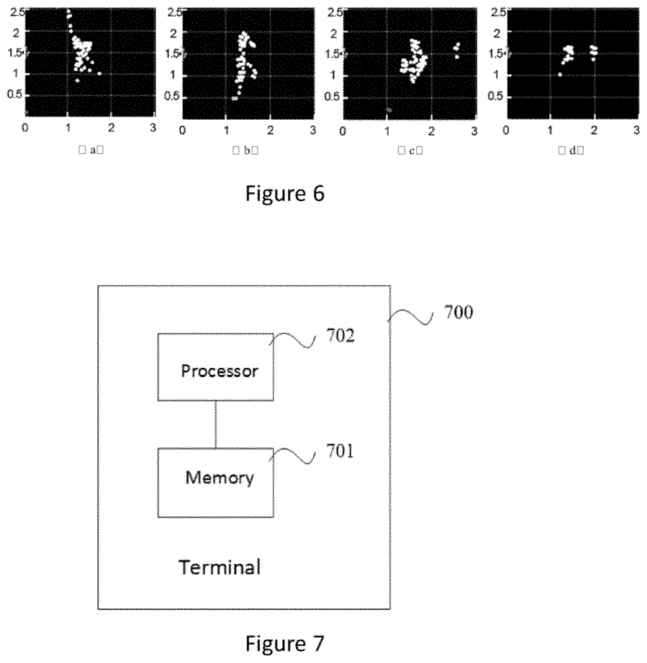

The FIG. 6 shows an example of point cloud maps of a human body during a falling process in this example. Herein, a horizontal axis is the Y-axis in the FIG. 5, and a vertical axis is the Z-axis in the FIG. 5. The FIG. 6 shows mapping pictures of a three-dimensional point cloud map on a plane determined by the Y-axis and Z-axis directions. The FIG. 6(a) shows a point cloud mapping picture of a state that a person stands and walks, the FIG. 6(b) shows a point cloud mapping picture of a state that a person stands and is about to fall, the FIG. 6(c) shows a point cloud mapping picture of a state before a person falls, and the FIG. 6(d) shows a point cloud mapping picture of a state that a person has fallen.

It should be noted that the point cloud map and point cloud mapping picture shown in the FIG. 5 and the FIG. 6 are only examples. In actual scenes, point cloud maps of different users in different states are different. In addition, in practical applications, point cloud data may carry color information, so the point cloud map obtained from point cloud data may be a color image.

In this example, the data processing terminal may include a preprocessing module 402, a stacked auto-encoder (SAE) network 403, a Softmax regression classifier 404, and an alarm module 405. For example, the data processing terminal may be a terminal independent of the UWB radar sensor 401. Alternatively, the data processing terminal and the UWB radar sensor 401 may be integrated and configured on a device (for example, a smart home control terminal).

In this example, the preprocessing module 402 may acquire point cloud data from the UWB radar sensor 401 and preprocess the point cloud data. For example, a noise threshold may be used to remove noises from the point cloud data. For example, point cloud data greater than the threshold a may be deleted from the point cloud map, and only point cloud data less than or equal to the threshold a may be retained. It should be noted that when the point cloud map is a color image, the preprocessing module 402 may convert the denoised point cloud map into a gray image, and then input it into a deep neural network (DNN) composed of the stacked auto-encoder network 403 and the Softmax regression classifier 404.

In this example, the stacked auto-encoder network 403 including two sparse auto-encoders is taken as an example. Herein, a weight w and a deviation b of the sparse auto-encoder are obtained by minimizing the following cost function:

J(w, b)=E(w, b)+β•D_{KL}(ρ, \hat{ρ}),

E(w, b) represents an error between the input data u and the output data y of the sparse auto-encoder. ρ is an average activation degree of the hidden layer neurons, \hat{ρ} is an actual activation degree of the hidden layer neurons, D_{KL}(ρ, \hat{ρ}) is a sparse penalty factor, and β is a weight for controlling the sparse penalty factor.

In order to avoid over-fitting, a regularization term is added to prevent weight values from being too high. Thus, E(w, b) may be defined as

$$E ( w , b ) = \frac{1}{2} {‖ y ( u , w , b ) - u ‖}^{2} + λ {‖ w ‖}^{2} ;$$

Here λ represents a regularization parameter.

In general, for a sparse auto-encoder, it is not specified which hidden layer neurons are inhibited, but a sparse parameter ρ that represents the average activity level of hidden layer neurons is specified. For example, when ρ=0.04 hidden layer neurons may be considered to be inhibited during 92% of the time and may be activated with an opportunity of only 4%. In order to obtain the average activation degree ρ a relative entropy, namely KL divergence, may be introduced to measure the difference between the actual activation degree \hat{ρ} and the expected activation degree ρ of neurons, and then this measurement is added to the objective function as regularization to train the sparse auto-encoder. Therefore, a penalty item that may be added is β•D_{KL}(ρ, \hat{ρ}). Once \hat{ρ} deviates from the expected activation degree ρ, this error increases sharply, then the error is added to the objective function as a penalty term to guide the sparse auto-encoder to learn sparse feature expression. Therefore, β•D_{KL}(ρ, \hat{ρ}) is also responsible for obtaining sparse representation.

In this example, two sparse auto-encoders are used for extracting features, and by computing the sparse representation, the most prominent feature is extracted. Since an image of human motion contains significant amount of useful information, the information is extracted from multiple layers, wherein each layer represents different content of the input data, For example, a layer (sparse auto-encoder) may learn edges, while the next layer (sparse auto-encoder) may learn shapes which contain these edges. The manner of learning input representations in multiple levels may be achieved by using a stacked auto-encoder network, where the output of a sparse auto-encoder is input to the next sparse auto-encoder.

In this example, the output data z of the stacked auto-encoder network 403 are input to a Softmax regression classifier 404. The output of the Softmax regression classifier 404 is defined as an L-dimensional vector, where L denotes the number of states which are to be distinguished. In this example, there are only two state categories, falling and non-falling. The lₜₕ element of the output vector contains a probability pₗ for the event that the data z belongs to the category label yₗ. The element with the highest probability determines the state category corresponding to the data z.

The probability pₗ is defined as

$${p}_{l} = \frac{1}{{\sum }_{l = 1}^{L} {e}^{z {θ}_{l}}} {e}^{z {θ}_{l}} , l = 0 , 1 ;$$

Where, z represents output data of the SAE network; l=0 represents non-falling and l=1 represents falling. In addition, the parameter θₗ is determined by minimizing an objective function, which is obtained based on the indicator function 1{⋅}, and the formula is as follows:

$$J ( θ ) = {\sum }_{l} 1 \{ y = l \} log \frac{{e}^{z {θ}_{l}}}{{\sum }_{l = 1}^{L} {e}^{z {θ}_{l}}} .$$

Typically, a regularization term is added into the above formula to prevent over-fitting.

In this example, the non-falling state may include walking, sitting, standing, bending and other normal states. The falling state may include all kinds of falling state, for example, falling forward, falling backward, etc.

In this example, the collected point cloud data of falling and non-falling states may be used for training and testing of the stacked auto-encoder network 403 and the Softmax regression classifier 404. Because the target object is the elderly, in consideration of the physical condition of the elderly, the elderly cannot simulate falling for the purpose of algorithm training. Therefore, in this example, the stacked auto-encoder network is used for feature extraction, and the problem of lack of actual training data is solved by an unsupervised method of mixed supervision. For example, by a stacked auto-encoder network, starting with sensor data from a UWB radar sensor, a feature space may be customized in an unsupervised manner. In this example, training data obtained from a young person's simulated falling and non-falling may be used to train the Softmax regression classifier. In this example, the stacked auto-encoder network and the Softmax regression classifier may be tested by using non-falling data of the elderly.

In this example, the data processing terminal may continuously receive multiple frames of the point cloud maps to continuously detect whether the elderly falls in the bathroom. The alarm module 405 may be adapted to determine a duration in which the elderly is in the falling state, after the Softmax regression classifier 404 determines that the elderly is in the falling state in the monitoring area. When the duration in which the elderly is in the falling state in the monitoring area meets a preset condition (e.g., greater than or equal to a time threshold), alarm information will be generated and at least one of the following will be performed: sending alarm information to the target terminal (e.g. a bound cell phone of a family member of the elderly); displaying the alarm information; and playing a voice corresponding to the alarm information.

In this example, a visual point cloud map is obtained based on the millimeter-wave radar signal for state recognition. The user does not need to wear a wearable device, and there is no need to configure a camera in the monitoring area, so the privacy of the user can be well protected, which is suitable for a privacy space such as a toilet or a bathroom. Moreover, the UWB radar sensor in this example is installed on the wall perpendicular to the ground, so that point cloud data that can reflect the height information of the target may be obtained, which is beneficial to improving the fall detection effect. In addition, in this example, the human body features in the point cloud map may be extracted automatically through the deep learning of the stacked auto-encoder network, so as to identify whether the human body falls.

The FIG. 7 is a schematic diagram of a terminal provided by an embodiment of this application. As shown in the FIG. 7, the embodiment of this application provides a terminal 700 including a memory 701 and a processor 702, the memory 701 is used for storing a detection program which, when executed by the processor 702, cause the processor to implement steps of the detection method provided by the above embodiment, such as the steps shown in the FIG. 1. The skilled in the art can understand that the structure shown in FIG. 7 is only a schematic diagram of part of the structure related to the solution of this application, but does not constitute a limitation to the terminal 700 on which the solution of this application is applied. The terminal 700 may contain more or fewer parts than shown in the figure, or combine some parts, or have different layouts of parts.

The processor 702 may include, but not limited to, a processing device such as a microprocessor (for example, Microcontroller Unit (MCU)) or a programmable logic device (for example, Field Program sable Gate Array (FPGA)), The memory 701 may be used for storing software programs and modules of application software, such as program instructions or modules corresponding to the detection method in this embodiment. The processor 702 implements various functional applications and data processing, such as implementing the fall detection method provided by the embodiment, by running software programs and modules stored in memory 701. The memory 701 may include high-speed ram and may also include non-transitory memory, such as one or more magnetic storage devices, flash memories, or other non-transitory solid-state memories. In some examples, the memory 701 may include a memory configured remotely to the processor 702, the remote memory may be connected to the terminal 700 over a network. Examples of the network include, but not limited to, Internet, Intranet, LAN, mobile communication network, and a combination thereof.

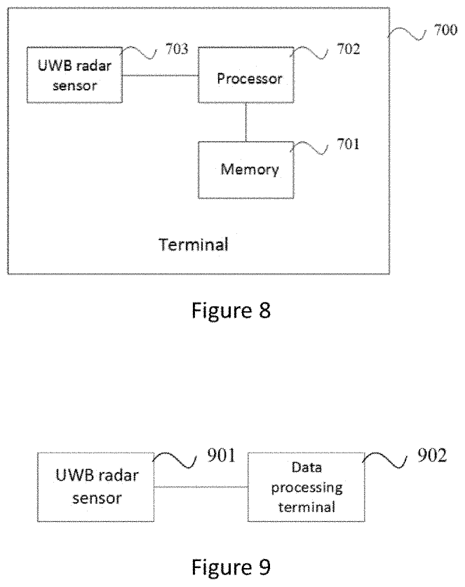

The FIG. 8 is a schematic diagram of an example of a terminal provided by an embodiment of this application. In an exemplary embodiment, as shown in FIG. 8, the terminal 700 of this embodiment may also include a UWE radar sensor 703 connected to the processor 702. A plane where the UWB radar sensor 703 is configured is perpendicular to the ground in the monitoring area. The UWB radar sensor 703 may be adapted to transmit a millimeter-wave radar signal and receive a returned millimeter-wave radar signal in the monitoring area, and generate point cloud data based on the received millimeter-wave radar signal.

In addition, the description of the relevant implementation process of the terminal provided by this embodiment may refer to the relevant description of the above detection method and detection device, so it is not repeated here.

The FIG. 9 is a schematic diagram of a detection system provided in an embodiment of this application. As shown in the FIG. 9, the detection system provided by this embodiment is used to detect a state of a target object in a monitoring area, and includes: a UWB radar sensor 901 and a data processing terminal 902.

The UWB radar sensor 901 may be adapted to transmit a millimeter-wave radar signal and receive a returned millimeter-wave radar signal in the monitoring area; and generate point cloud data according to the received millimeter-wave radar signal, The data processing terminal 902 may be adapted to acquire the point cloud data from the UWB radar sensor 901; preprocess the point cloud data; extract features of the preprocessed point cloud data through a stacked auto-encoder network to obtain the output data; classify the output data by a classifier to obtain a classification result; and determine the state of the target object in the monitoring area according to the classification result.

In an exemplary embodiment, states of the target object in the monitoring area may include: a falling state, and a non-falling state. The, data processing terminal 902 may also be adapted to, after determining that the target object is in the falling state in the monitoring area, when a duration in which the target object is in the falling state in the monitoring area meets a preset condition, generate alarm information and execute at least one of the following: sending the alarm information to a target terminal (for example, sending the alarm information to a bound cell phone of a family member of the user); displaying the alarm information (for example, displaying the alarm information through a human-computer interaction interface of the data processing terminal 902); and playing a voice corresponding to the alarm information (for example, playing an alarm voice through a speaker of the data processing terminal 902).

In addition, the description of the relevant implementation process of the detection system provided by this embodiment may refer to the relevant description of the detection method and detection device described above, so it is not repeated here,

In addition, an embodiment of this application also provides a computer readable medium in which a detection program is stored, and when the detection program is executed by a processor, steps of the detection method provided by the above embodiment, such as the steps shown in the FIG. 1, are implemented.

One of ordinary skill in the art could understand that all or some of the steps, systems, and functional modules/units in the methods disclosed above may be implemented as software, firmware, hardware, and their appropriate combinations. In the hardware embodiment, the division between functional modules/units mentioned in the above description does not necessarily correspond to the division of physical components, For example, a physical component may have multiple functions, or a function or step may be performed by several physical components working together. Some or all of the components may be implemented as software executable by processors, such as digital signal processors or microprocessors, or as hardware, or as integrated circuits, such as application-specific integrated circuits. Such software may be distributed on computer readable media, which may include computer storage media (or non-temporary media) and communication media (or temporary media). As well known to one of ordinary skill in the art, the term, computer storage media, includes transitory, non-transitory, removable, non-removable media implemented in any method or technology used for storing information (such as computer readable instructions, data structures, program modules, or other data). Computer storage media include, but not limited to, RAM, ROM, EEPROM, flash memory or other storage technology, CD-ROM, Digital Video Disk (DVD) or other optical disk storage, magnetic box, magnetic tape, disk storage or other magnetic storage device, or any other media that may be used to store desired information and may be accessed by the computer. In addition, it is well known to one of ordinary skill in the art that the communication media usually include computer-readable instructions, data structures, program modules, or other data in modulated data signals such as carriers or other transmission mechanisms, and may include any information transmission medium.

Basic principles and main features of this application and advantages of this application are illustrated and described above, This application is not limited by the above embodiments. What is described in the above embodiments and the specification only explains the principle of this application. Without departing from the spirit and scope of this application, there will be various changes and improvements for this application, and these changes and improvements shall fall within the protection scope of the present application.

1. A detection method for detecting a state of a target object in a monitoring area, comprising:
acquiring point cloud data obtained based on a millimeter-wave radar signal in the monitoring area, and preprocessing the point cloud data;
extracting features of the preprocessed point cloud data through a stacked auto-encoder network to obtain output data; and
classifying the output data by a classifier to obtain a classification result, and determining the state of the target object in the monitoring area according to the classification result.

2. The method of claim 1, wherein the millimeter wave radar signal is received by an ultra-wideband radar sensor configured in the monitoring area, and a plane where the ultra-wideband radar sensor is configured is perpendicular to the ground in the monitoring area.

3. The method of claim 2, wherein before acquiring the point cloud data obtained based on the millimeter wave radar signal in the monitoring area, the method further comprises:
transmitting a millimeter-wave radar signal and receiving a returned millimeter-wave radar signal in the monitoring area through the ultra-wideband radar sensor; and generating the point cloud data according to the received millimeter-wave radar signal.

4. The method of claim 1, wherein the stacked auto-encoder network comprises two sparse auto-encoders, which are respectively used to extract different features from the preprocessed point cloud data.

5. The method of claim 1, wherein, the classification result comprises: a probability that the output data belong to any state;
determining the state of the target object in the monitoring area according to the classification result, comprises: determining a maximum probability in the classification result; and determining a state corresponding to the maximum probability as the state of the target object in the monitoring area.

6. The method of claim 1, wherein preprocessing the point cloud data, comprises: removing noises in the point cloud data by using a noise threshold.

7. The method of claim 1, wherein states of the target object in the monitoring area comprise a falling state and a non-falling state;
the method further comprises: after determining that the target object is in the falling state in the monitoring area, when a duration in which the target object is in the falling state in the monitoring area meets a preset condition, generating alarm information, and executing at least one of the following:
sending the alarm information to a target terminal;
displaying the alarm information; and
playing a voice corresponding to the alarm information.

8. A detection device for detecting a state of a target object in a monitoring area, comprising:
a preprocessing module, adapted to acquire point cloud data obtained based on a millimeter-wave radar signal in the monitoring area and preprocess the paint cloud data;
a stacked auto-encoder network, adapted to extract features of the preprocessed point cloud data to obtain output data; and
a classifier; adapted to classify the output data to obtain a classification result, and determine the state of the target object in the monitoring area according to the classification result.

9. A terminal, comprising a processor and a memory; wherein the memory stores a detection program, which, when executed by the processor, cause the processor to implement steps of the detection method of claim 1.

10. The terminal of claim 9, wherein the terminal further comprises: an ultra-wideband radar sensor, connected to the processor; a plane where the ultra-wideband radar sensor is configured is perpendicular to the ground in the monitoring area; the ultra-wideband radar sensor is adapted to transmit a millimeter-wave radar signal and receive a returned millimeter-wave radar signal in the monitoring area, and generate the point cloud data according to the received millimeter-wave radar signal.

11. A detection system for detecting a state of a target object in a monitoring area, comprising: an ultra-wideband radar sensor and a data processing terminal;
the ultra-wideband radar sensor is adapted to transmit a millimeter-wave radar signal and receive a returned millimeter-wave radar signal in the monitoring area, and generate point cloud data according to the received millimeter-wave radar signal;
the data processing terminal is adapted to acquire the point cloud data from the ultra-wideband radar sensor; preprocessing the point cloud data; extract features of the preprocessed point cloud data through a stacked auto-encoder network to obtain output data; classify the output data by a classifier to obtain a classification result; and determine the state of the target object in the monitoring area according to the classification result.

12. The system of claim 11, wherein states of the target object in the monitoring area comprise a falling state and a non-falling state;
the data processing terminal is further adapted to: after determining that the target object is in the falling state in the monitoring area, when a duration in which the target object is in the falling state in the monitoring area meets a preset condition, generate alarm information and execute at least one of the following:
sending the alarm information to a target terminal;
displaying the alarm information; and
playing a voice corresponding to the alarm information.

13. A computer-readable medium, in which a detection program is stored for implementing steps of t detection method of claim 1 when the detection program is executed by a processor.
